(19) United States
(12) Patent Application Publication
(10) Pub. No.: US 2018/0139655 A1
(43) Pub. Date: May 17, 2018

(54) MANAGEMENT DEVICE AND MANAGEMENT METHOD THEREOF FOR CLOUD RADIO ACCESS NETWORK AND USER EQUIPMENT

(71) Applicant: Institute For Information Industry, Taipei (TW)

(72) Inventors: Chun-Yen HSU, Taipei City (TW); Kuang-Wei SU, Taipei City (TW)

(21) Appl. No.: 15/369,871

(22) Filed: Dec. 5, 2016

(30) Foreign Application Priority Data
Nov. 17, 2016 (TW) 105137605

(51) Int. Cl. H04W 28/16; H04W 24/08

(52) U.S. Cl. CPC H04W 28/16; H04W 88/085; H04W 24/08

(57) ABSTRACT

A management device and a management method for cloud radio access network (C-RAN) and a user equipment are provided. The management device connects to a plurality of baseband units (BBUs) and receives a resource utilization index report from the BBUs. When there is an imbalanced BBU among the BBUs, the resource utilization index of which is in a critical region, the management device selects at least one target BBU and calculates a pause time. Afterwards, the management device generates and transmits a data transfer indication message to the imbalanced BBU to make the imbalanced BBU transmit a pause indication message via at least one remote radio head (RRH) to at least one user equipment for entering a pause mode and transfer service data associated with the at least one user equipment to the at least one target BBU.

### PRIORITY

This application claims priority to Taiwan Patent Application No. 105137605 filed on Nov. 17, 2016, which is hereby incorporated by reference in its entirety.

### FIELD

The present invention relates to a management device and a management method thereof for a cloud radio access network and a user equipment. Specifically, the management device of the present invention determines whether there is an imbalanced baseband unit (BBU) based on resource utilization indexes of a plurality of BBUs, and makes the imbalanced BBU relocate at least one remote radio head (RRH) to other BBUs. Meanwhile, before the relocation proceeds, the imbalanced BBU transmits via the at least one RRH a pause indication message to a user equipment connected to the imbalanced BBU so that the user equipment enters a pause mode.

### BACKGROUND

With the development of the science and technology, user equipments such as smart phones and tablet computers have been widely used. In recent years, the cloud radio access network (C-RAN) technology has been developed. In C-RAN, remote radio heads (RRHs) are centrally managed by BBUs to achieve centralized and efficient baseband processing.

In the C-RAN, a user equipment connects to the BBU via the RRH. When the load among the BBUs is imbalanced, some of the RRHs may need to be relocated from one BBU to others to balance load among them. However, due to inconsistent configuration, some system parameters may not be the same between the BBUs. During the process of relocating the RRH from the source BBU to target BBUs, the system parameters may be changed. Such a system parameter change caused by RRH relocation can make UE loss its connectivity. On the other hand, the latency of RRH relocation also makes the synchronization of UE real-time information ((e.g., channel status, power control setting and so on) difficult.

Accordingly, there is an urgent need in the art to provide a management mechanism, which can address the aforementioned system parameter inconsistency and UE information synchronization issues caused by RRH relocation. This also prevents the UE from disconnected because of link information asynchronization.

### SUMMARY

The disclosure includes a management mechanism, which determines whether an imbalanced BBU exists among a plurality of BBUs, selects at least one target BBU and calculates a pause time based on the number of RRHs needed to be relocated as well as the volume of service data needed to be transferred from the imbalanced BBU to the target BBUs. Thereafter, by instructing a user equipment connecting to the RRH to be relocated to enter a pause mode and to keep in the pause mode during the pause time, the management mechanism of the present invention can prevent the problems such as the disconnection of the user equipment or the loss of packet caused by RRH relocation.

The disclosure includes a management device for a C-RAN. The management device comprises a network interface and a processor. The network interface connects to a plurality of BBUs. The processor is electrically connected to the network interface and can be configured to execute the following steps:

(a) receiving a resource utilization index report that indicates a resource utilization index from each of the BBUs via the network interface;

(b) among the BBUs, determining whether there is an imbalanced BBU, whose resource utilization index is in a critical region;

(c) when the imbalanced BBU exists, determining at least one RRH to be relocated among a plurality of RRHs connecting to the imbalanced BBU, and evaluating a volume of service data needed to be transferred, wherein the service data are associated with at least one user equipment connecting to the imbalanced BBU via the at least one RRH;

(d) selecting, from the BBUs, at least one target BBU whose resource utilization index is in a loadable region and calculating a pause time according to the number of the at least one RRH and the volume of service data;

(e) generating a data transfer indication message carrying the pause time and identification information of the at least one target BBU;

(f) after generating the data transfer indication message, transmitting the data transfer indication message via the network interface to the imbalanced BBU to make the imbalanced BBU execute the following steps according to the data transfer indication message: generating a pause indication message carrying the pause time; transmitting the pause indication message via the at least one RRH to the at least one user equipment so that the at least one user equipment enters a pause mode and keeps in the pause mode during the pause time; and transferring the service data associated with the at least one user equipment to the at least one target BBU.

The disclosure also includes a management method for a management device for a C-RAN. The management device comprises a network interface and a processor. The network interface connects to a plurality of BBUs. The processor is electrically connected to the network interface. The management method is executed by the processor and can comprise the following steps:

(a) receiving a resource utilization index report indicating a resource utilization index from each of the BBUs via the network interface;

(b) among the BBUs, determining whether there is an imbalanced BBU, whose resource utilization index is in a critical region;

(c) when the imbalanced BBU exists, determining at least one RRH to be relocated among a plurality of RRHs connecting to the imbalanced BBU, and evaluating a volume of service data needed to be transferred, wherein the service data are associated with at least one user equipment connecting to the imbalanced BBU via the at least one RRH;

(d) selecting, from the BBUs, at least one target BBU whose resource utilization index is in a loadable region and calculating a pause time according to the number of the at least one RRH and the volume of service data;

(e) generating a data transfer indication message carrying the pause time and identification information of the at least one target BBU;

(f) after generating the data transfer indication message, transmitting the data transfer indication message via the network interface to the imbalanced BBU to make the imbalanced BBU execute the following steps according to the data transfer indication message: generating a pause indication message carrying the pause time; transmitting the pause indication message via the at least one RRH to at least one user equipment so that the at least one user equipment enters a pause mode and keeps in the pause mode during the pause time; and transferring service data associated with the at least one equipment to the at least one target BBU.

The disclosure further includes a user equipment, which comprises a transceiver and a processor. The processor is electrically connected to the transceiver and can be configured to receive a pause indication message carrying a pause time via the transceiver from an imbalanced BBU and through an RRH, and make the user equipment enter a pause mode in response to the pause indication message and keep in the pause mode during the pause time. After the pause time expires, the processor further makes the user equipment switch back to a normal transmission mode and receive a broadcast signal from a target BBU and through the RRH via the transceiver so as to retrieve a system parameter carried in the broadcast signal. The imbalanced BBU transfers service data of the user equipment to the target BBU.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A to FIG. 1C respectively depict different implementations of a first embodiment of the present invention;

FIG. 2A to FIG. 2C respectively depict different implementations of a second embodiment of the present invention;

FIG. 3 is a schematic view of a management device 1 of the present invention;

FIG. 4 is a flowchart diagram of a management method of the present invention; and

FIG. 5 is a schematic view of a user equipment 4 of the present invention.

### DETAILED DESCRIPTION

In the following description, the present invention will be explained with reference to example embodiments thereof. It shall be appreciated that these example embodiments are not intended to limit the present invention to any particular examples, embodiments, environment, applications or implementations described in these example embodiments. Therefore, description of these example embodiments is only for purpose of illustration rather than to limit the present invention, and the scope claimed in this application shall be governed by the claims.

In the following example embodiments and the attached drawings, elements unrelated to the present invention are omitted from depiction; and dimensional relationships among individual elements in the attached drawings are illustrated only for ease of understanding, but not to limit the actual scale.

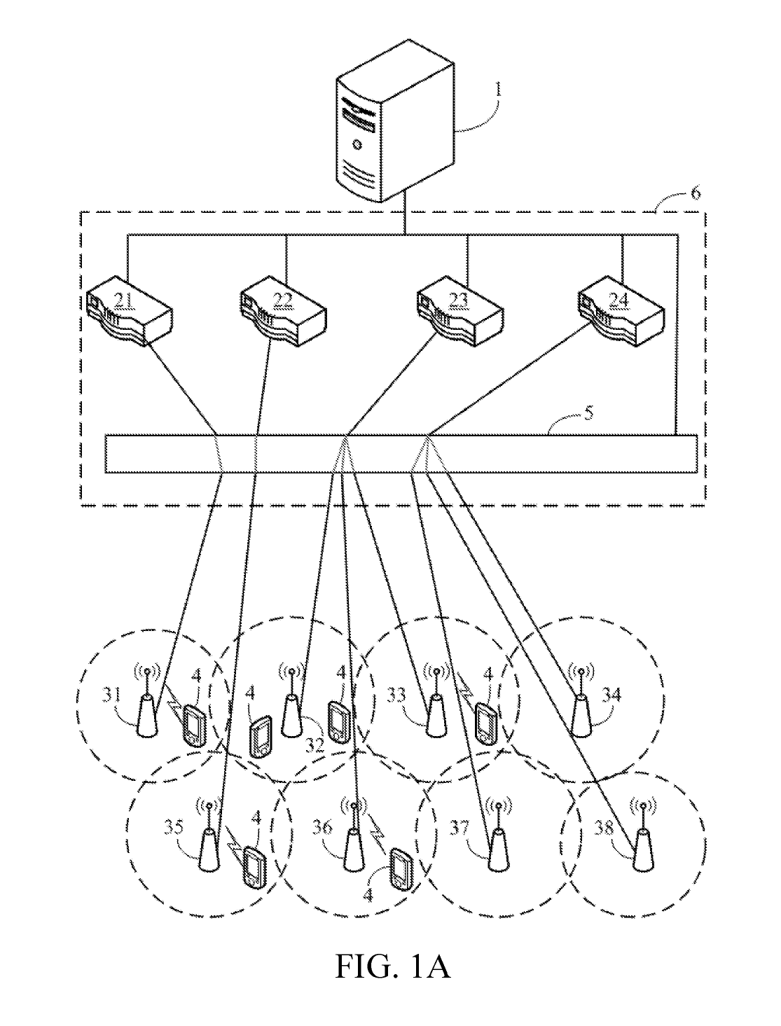

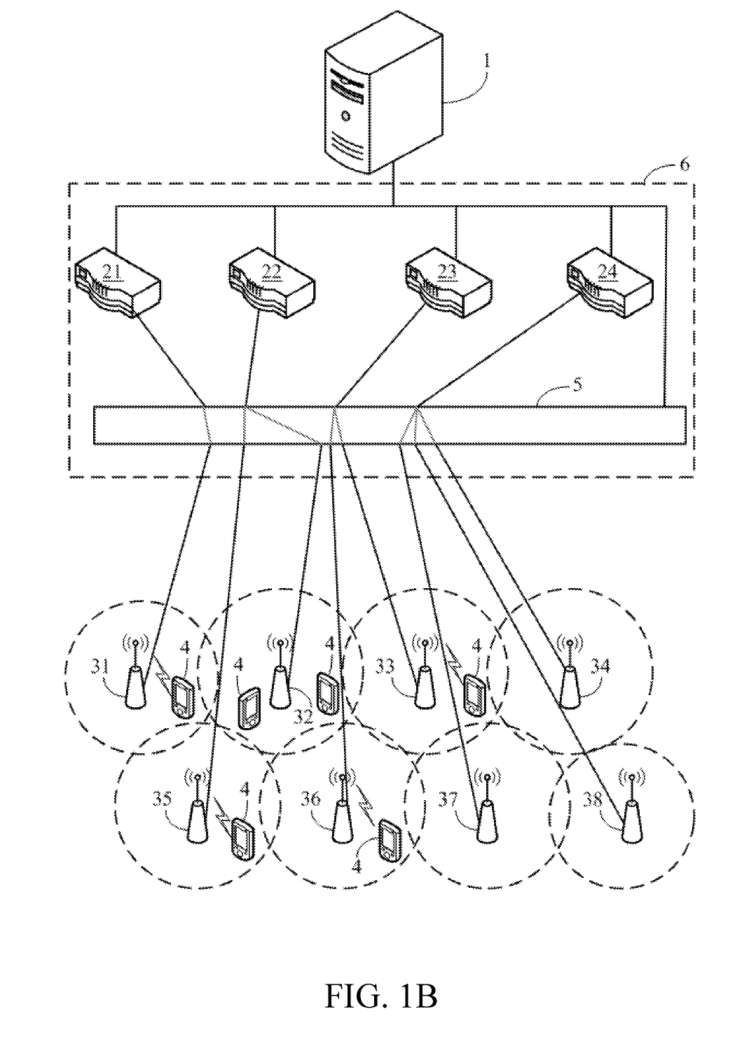

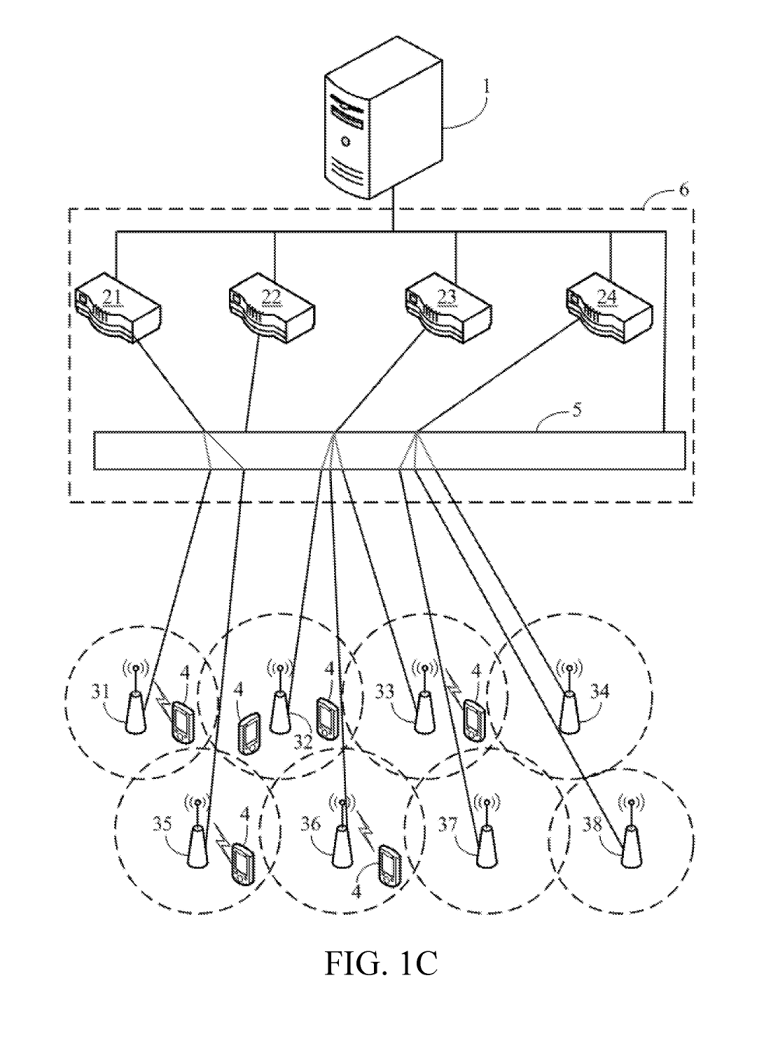

Please refer to FIG. 1A to FIG. 1C for a first embodiment of the present invention. FIG. 1A depicts an implementation of a management device 1, baseband units (BBUs) 21 to 24, remote radio heads (RRHs) 31 to 38, and user equipments (UEs) 4 of the present invention. In this embodiment, the management device 1 is a server and is connected to the plurality of BBUs 21 to 24. The BBUs 21 to 24 are connected to the RRHs 31 to 38 via a switch assembly 5, and the BBUs 21 to 24 form a BBU pool 6 together with the switch assembly 5. The BBU pool 6 belongs to the core network in the C-RAN architecture, and is connected to other apparatuses in the core network, e.g., a serving gateway (S-GW), a packet data network gateway (P-GW), a mobile management entity (MME) or the like.

In the BBU pool 6, the BBUs 21 to 24 are interconnected with each other. The switch assembly 5 may be represent of several switches (but not limited thereto), each of the switches is connected to a plurality of BBUs and a plurality of RRHs, and the switches may also be interconnected with each other. It shall be appreciated that, only four BBUs 21 to 24 and eight RRHs 31 to 38 are shown in the attached drawings for simplification to depict the present invention. However, as will be readily appreciated by those who have ordinary skill in the art, based on practical establishment requirements of telecommunication networks, the BBU pool 6 of the present invention may include any number of BBUs, and each of the BBUs may be connected to one or more RRHs. Therefore, the number of the BBUs and the RRHs connected to the BBUs are not intended to limit the scope of the present invention.

The management device 1 may manage one or more BBU pools 6 and receive a resource utilization index report from each of the BBUs 21 to 24, and the resource utilization index report indicates a resource utilization index of each of the BBUs 21 to 24. The management device 1 determines whether there is an imbalanced BBU whose resource utilization index of which is in a critical region among the BBUs 21 to 24 according to the resource utilization index of each of the BBUs 21 to 24.

The critical region may be a value region where the resource utilization index is greater than an upper threshold value or a region where the resource utilization index is lower than a lower threshold value. Similarly, the management device 1 is depicted as being connected to one BBU pool 6 in the attached drawings of the present invention for simplification. However, the implementation where the management device 1 is connected to several BBU pools 6 will be readily appreciated by those who have ordinary skill in the art based on the description herein, and thus will not be further described herein.

When the imbalanced BBU exists among the BBUs 21 to 24, the management device 1 determines the RRH needed to be relocated among a plurality of RRHs connecting to the imbalanced BBU. Then, the management device 1 evaluates the volume of service data needed to be transferred. The service data are associated with at least one UE connecting to the imbalanced BBU via the at least one RRH. Based on the number of the at least one RRH needed to be relocated and the volume of service data needed to be transferred, the management device 1 selects at least one target BBU whose resource utilization index is not in a loadable region from the BBUs 21 to 24, and calculate a pause time.

It shall be appreciated that, the resource utilization index of the target BBU is in a loadable region if and only if the resource utilization index of the target BBU will not in a critical region after receiving the service data associated with the UEs, i.e., the resource utilization index of the target BBU ranges between an upper threshold value and a lower threshold value. Therefore, if the management device 1 evaluates that the resource utilization index of a BBU will be in the critical region after receiving the service data associated with the UEs, then the management device 1 will not select the BBU as the target BBU. Moreover, if a relatively large number of RRHs need to be relocated and a large amount of the service data need to be transferred by the imbalanced BBU, the management device 1 may select several target BBUs to relocate the RRHs and transfer the service data. It should be noted that service data may include some service related parameters of UEs, for example, quality of service (QoS), connection time, link quality, profile information, configuration and user information that are required to be transferred from the source BBU to the target BBU for maintaining the service continuity during the RRH relocation.

After the pause time is calculated, the management device 1 generates a data transfer indication message carrying the pause time and identification information of the at least one target BBU, and transmits the data transfer indication message to the imbalanced BBU. The imbalanced BBU generates a pause indication message according to the data transfer indication message after receiving the data transfer indication message. The pause indication message carries the pause time. Thereafter, the imbalanced BBU transmits the pause indication message to the UE(s) connected to the imbalanced BBU via the at least one RRH needed to be relocated. After receiving the pause indication message, the UE enters a pause mode and keeps in the pause mode during the pause time.

It shall be appreciated that, in an embodiment, the user equipment may enter the pause mode immediately after receiving the pause indication message. However, in another embodiment, the imbalanced BBU may further determine a pause start time and include the pause start time in the pause indication message. So the UE enters a pause mode at the pause start time after receiving the pause indication message.

The UE suspends signal transmission with the RRH when it is in the pause mode. In other words, transmission of any uplink signal and downlink signal between the UE and the RRH needed to be relocated is suspended when the UE is in the pause mode until the pause time expires. Meanwhile, during the time period when the UE is in the pause mode, the imbalanced BBU transfers the service data associated with the UE to at least one target BBU. Thereafter, in response to that the imbalanced BBU transfers the service data to the target BBU, the management device 1 can control the switch connected with the imbalanced BBU to switch the corresponding RRH to be connected to the target BBU.

After the pause time expires, the UE switches back to a normal transmission mode and starts to receive a broadcast signal transmitted from the target BBU through the RRH connected with the target BBU so as to achieve system synchronization with the target BBU. In detail, the broadcast signal carries system parameters (e.g., Master Information Block (MIB), System Information Block (SIB) and frame number) of the target BBU, so the UE can obtain the system parameters of the target BBU for subsequent data transmission after receiving the broadcast signal.

For example, as shown in FIG. 1A and FIG. 1B, when the critical region is the region where the resource utilization index is greater than an upper threshold value (e.g., 90%) and the resource utilization index of the BBU 23 is 93%, the management device 1 can determine, according to the resource utilization index reports received from the BBUs 21 to 24, that the BBU 23 is an imbalanced BBU because its resource utilization index is too high, and part of RRHs need to be relocated to achieve load balance among the BBUs 21 to 24. Thereafter, the management device 1 determines the at least one RRH among all RRHs 32, 33 and 36 connected with the BBU 23 to be relocated to another BBU in order to make the resource utilization index of the BBU 23 to reduce to below 90%.

The management device 1 can randomly select the RRHs needed to be transferred or select the RRHs needed to be relocated based on the number of UEs connected with the RRHs. Here, if the management device 1 determines that the RRH 32 needs to be relocated, then the management device 1 evaluates the volume of service data needed to be transferred. The service data are associated with the UEs 4 connecting to the imbalanced BBU 23 via the RRH 32. Next, the management device 1 selects at least one target BBU whose the resource utilization index is in a loadable region from other BBUs 21, 22 and 24, and calculates a pause time according to the number of the RRHs needed to be relocated (in this example, there is only one RRH 32 needed to be relocated) and the volume of service data needed to be transferred.

The management device 1 may select one or more BBUs whose resource utilization indexes are relatively low from other BBUs as the target BBUs, or select the target BBUs based on any load optimization algorithm, but it is not limited thereto. It is assumed that the management device 1 selects the BBU 22 as the target BBU. Thereafter, the management device 1 generates a data transfer indication message carrying the pause time and identification information of the BBU 22, and transmits the data transfer indication message to the BBU 23.

After receiving the data transfer indication message, the BBU 23 generates a pause indication message which carries the pause time according to the data transfer indication message, and transmits the pause indication message to the UEs 4 connected with the BBU 23 via the RRH 32 needed to be relocated. After receiving the pause indication message, the UEs 4 enter the pause mode, i.e., the UEs 4 suspend the data transmission with the RRH 32, and keep in the pause mode during the pause time. Meanwhile, in response to the data transfer indication message, the BBU 23 transfers the service data associated with the UE 4 to the BBU 22 within the pause time.

After the pause time expires, the UEs 4 switch back to the normal transmission mode and receive a broadcast signal transmitted from the BBU 23 through the RRH 32 so as to achieve synchronization of the system parameters. As can be known from the above descriptions, the UEs 4 can enter the pause mode in response to the pause indication message and suspend the signal transmission during the time period in which the BBU 23 transfers the service data associated with the UEs 4 to the BBU 22, thereby preventing the UE from disconnected because of link information asynchronization.

For another example, as shown in FIG. 1A and FIG. 1C, when the critical region is the region where the resource utilization index is lower than a lower threshold value (e.g., 25%) and the resource utilization index of the BBU 22 is 15%, the management device 1 can determine, according to the resource utilization index reports received from the BBUs 21 to 24, that the BBU 22 is an imbalanced BBU because its resource utilization index is too low, and the operational expenditure (OPEX) can be reduced by relocating all the RRHs connected to the BBU 22.

Next, the management device 1 selects at least one target BBU whose resource utilization index is in a loadable region from other BBUs 21, 23 and 24, and calculates a pause time according to the number of the RRHs needed to be relocated (in this example, there is only one RRH 35 needed to be relocated) and the volume of service data needed to be transferred. Similarly, the management device 1 selects at least one target BBU based on any load optimization algorithm, but it is not limited thereto. Assume that the management device 1 selects the BBU 21 as the target BBU, the management device 1 generates a data transfer indication message which carries the pause time and identification information of the BBU 21, and transmits the data transfer indication message to the BBU 22.

After receiving the data transfer indication message, the BBU 22 generates a pause indication message carrying the pause time according to the data transfer indication message, and transmits the pause indication message to the at least UE 4 connected with the BBU 22 via the RRH 35. After receiving the pause indication message, the at least one UE 4 enters the pause mode, i.e., the at least one user equipment 4 suspends the data transmission with the RRH 35, and keeps in the pause mode during the pause time. Meanwhile, the BBU 22 transfers the service data associated with the at least one UE 4 to the BBU 21 within the pause time.

Thereafter, the management device 1 may turn off the BBU 22 or make the BBU 22 enter a sleep mode to reduce the overall power consumption, thereby reducing the OPEX. Similarly, after the pause time expires, the UE 4 switches back to the normal transmission mode and receives a broadcast signal transmitted from the BBU 21 through the RRH 35 so as to achieve synchronization of the system parameters.

It shall be appreciated that, in other exemplary examples, the management device 1 may select different target BBUs for RRHs of different imbalanced BBUs based on various load optimization algorithms when there are several imbalanced BBUs. Various variants of exemplary examples shall be appreciated by those who have ordinary skill in the art based on the above description of the exemplary example, and thus will not be further described herein.

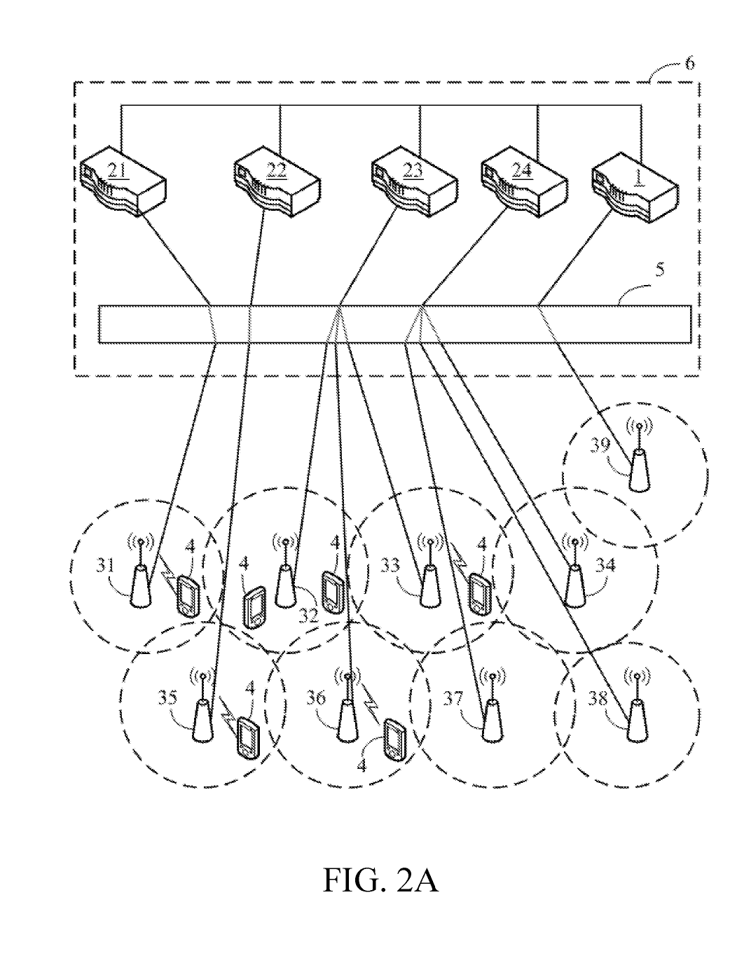

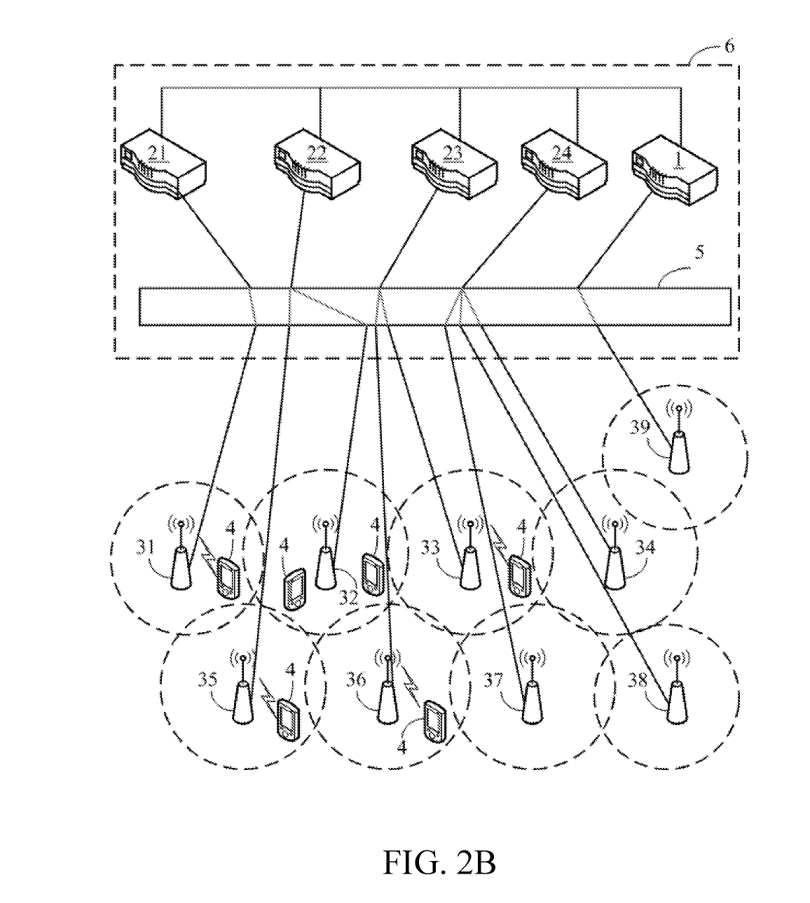

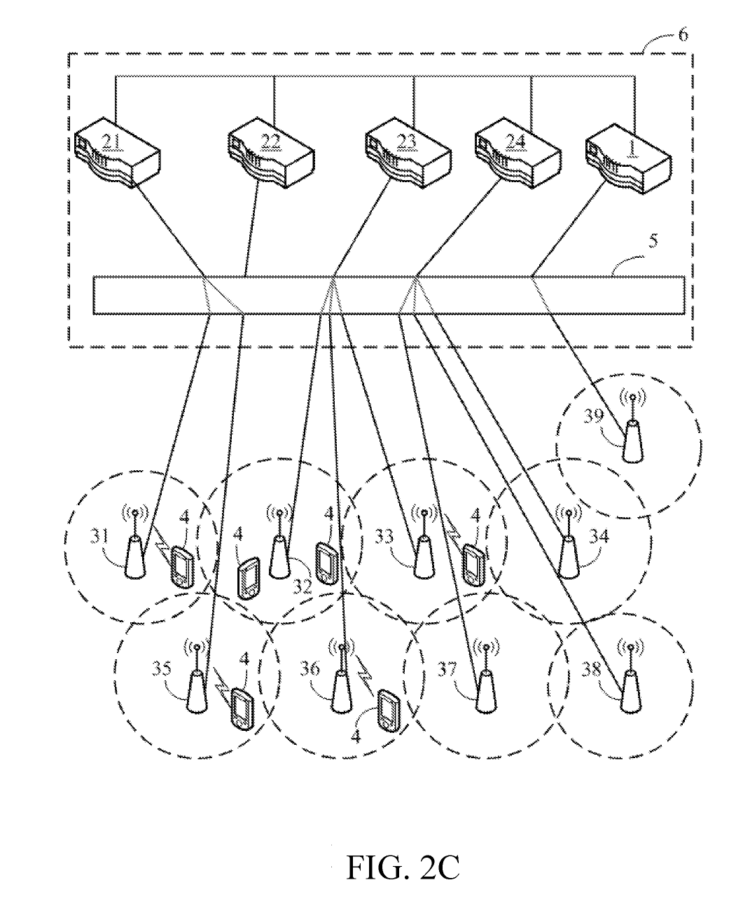

A second embodiment of the present invention is as shown in FIG. 2A to FIG. 2C. Different from the first embodiment, the management device 1 in this embodiment is a BBU in the BBU pool 6, and it may be connected to one or more RRHs (e.g., an RRH 39) via the switch assembly 5. The management device 1 not only can receive resource utilization index reports from the BBUs 21 to 24 to get the resource utilization index of each of the BBUs 21 to 24, but also can calculate its own resource utilization index. The management device 1 determines whether itself is an imbalanced BBU or whether there is an imbalanced BBU whose resource utilization index is in a critical region, among the BBUs 21 to 24 according to its own resource utilization index and the resource utilization index of each of the BBUs 21 to 24.

Similar to the example in FIG. 1B, in FIG. 2B, the management device 1 determines the BBU 23 as the imbalanced BBU, selects the BBU 22 as the target BBU and calculates the pause time according to the number of the RRHs needed to be relocated (in this example, there is only one RRH 32 needed to be relocated) and the volume of service data needed to be transferred by BBU 23. Thereafter, the management device 1 generates a data transfer indication message carrying the pause time and identification information of the BBU 22, and transmits the data transfer indication message to the BBU 23.

After receiving the data transfer indication message, the BBU 23 can generate a pause indication message carrying the pause time according to the data transfer indication message, and transmit the pause indication message to the UEs 4 connected with the BBU 23 via the RRH 32 needed to be relocated. The UEs 4 enter a pause mode and keep the pause mode during the pause time. Meanwhile, in response to the data transfer indication message, the BBU 23 transfers the service data associated with the UEs 4 to the BBU 22 within the pause time.

Similar to the exemplary example in FIG. 1C, in FIG. 2C, the management device 1 determines the BBU 22 as the imbalanced BBU, selects the BBU 21 as the target BBU and calculates the pause time according to the number of RRHs needed to be relocated (in this example, only the RRH 35 is needed to be relocated) and the volume of service data needed to be transferred by the BBU 22. Thereafter, the management device 1 generates a data transfer indication message carrying the pause time and identification information of the BBU 21, and transmits the data transfer indication message to the BBU 22.

After receiving the data transfer indication message, the BBU 22 can generate a pause indication message carrying the pause time according to the data transfer indication message, and transmit the pause indication message to the at least one UE 4 connected with the BBU 22 via the RRH 35. After receiving the pause indication message, the at least one UE 4 enters a pause mode. Meanwhile, the BBU 22 transfers the service data associated with the at least one UE 4 to the BBU 21 within the pause time. Thereafter, the management device 1 may turn off the BBU 22 or make the BBU 22 enter a sleep mode to reduce the overall power consumption, thereby reducing the OPEX.

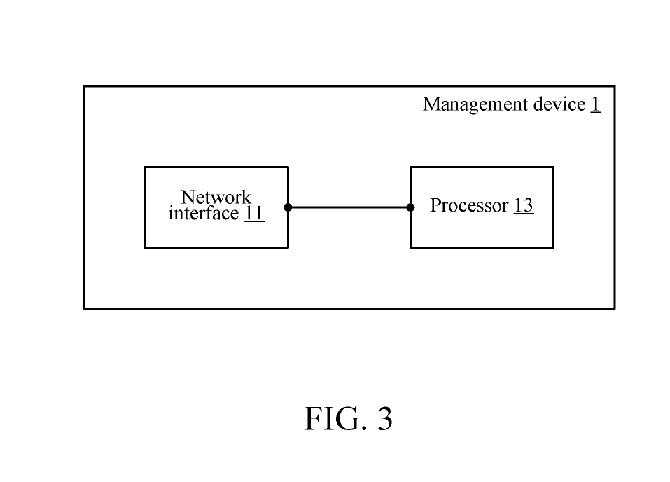

A third embodiment of the present invention is as shown in FIG. 3, which is a schematic view of the management device 1 of the present invention. The management device 1 comprises a network interface 11 and a processor 13. The network interface 11 is connected to a plurality of BBUs. The processor 13 is electrically connected to the network interface 11. The processor 13 receives a resource utilization index reports from each of the BBUs via the network interface 11, wherein the resource utilization index report indicates a resource utilization index, and the processor 13 determines whether there is an imbalanced BBU, the resource utilization index of which is in a critical region, among the BBUs.

As described above, when there is the imbalanced BBU, the processor determines at least one RRH connecting to the imbalanced BBU to be relocated, and evaluates the volume of service data needed to be transferred. The service data are associated with at least one UE connecting to the imbalanced BBU via the at least one RRH. The processor 13 selects at least one target BBU from the BBUs, and calculates a pause time according to the number of the at least one RRH needed to be relocated and the volume of service data needed to be transferred. The resource utilization index of the at least one target BBU is in a loadable region.

Thereafter, the processor 13 generates a data transfer indication message which carries the pause time and identification information of the at least one target BBU, and transmits the data transfer indication message via the network interface 11 to the imbalanced BBU after the data transfer indication message is generated. Then, after receiving the data transfer indication message, the imbalanced BBU generates a pause indication message carrying the pause time according to the data transfer indication message, and transmits the pause indication message via the at least one RRH to at least one UE connected to the imbalanced BBU via the at least one RRH. In this way, the at least one UE enters a pause mode in response to the pause indication message and keeps in the pause mode during the pause time. Meanwhile, the imbalanced BBU transfers the service data of the at least one user equipment to the at least one target BBU.

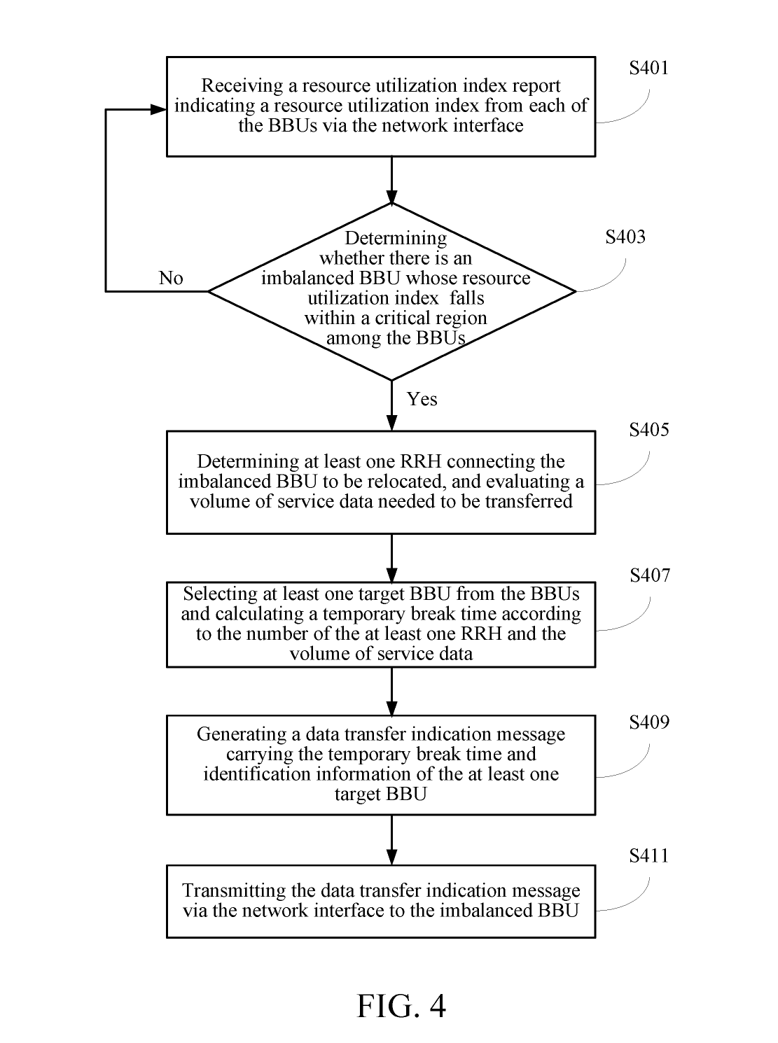

A fourth embodiment of the present invention is a management method, and a flowchart diagram thereof is as shown in FIG. 4. The management method is for use in a management device for a C-RAN (e.g., the management device 1 of the aforesaid embodiments). The management device comprises a network interface and a processor. The network interface connects to a plurality of BBUs. The processor is electrically connected to the network interface. The management method is executed by the processor.

First, in step S401, a resource utilization index report is received from each of the BBUs via the network interface, wherein the resource utilization index report indicates a resource utilization index. Thereafter, in step S403, it is determined whether there is an imbalanced BBU whose resource utilization index is in a critical region among the BBUs. If there is no imbalanced BBU among the BBUs, then the method returns to the step S401. Further speaking, the management device may periodically receive the resource utilization index report from each of the BBUs, or receive the resource utilization index report from each of the BBUs when the resource utilization indexes of the BBUs are updated. Therefore, the management device can periodically or continuously monitor whether there is an imbalanced BBU among the BBUs.

When the imbalanced BBU exists among the BBUs, step S405 is executed to determine at least one RRH connecting the imbalanced BBU to be relocated, and evaluate a volume of service data needed to be transferred. The service data are associated with at least one UE connecting to the imbalanced BBU via the at least one RRH. Next, in step S407, at least one target BBU is selected from the BBUs and a pause time is calculated according to the number of the at least one RRH and the volume of service data. As described above, the resource utilization index of the at least one target BBU is in a loadable region so that the resource utilization index of the at least one target BBU will not be in the critical region after receiving the transferred service data, thereby preventing the target BBU from becoming an imbalanced BBU after receiving the transferred service data.

Thereafter, in step S409, a data transfer indication message carrying the pause time and an identification information of the at least one target BBU is generated. Finally, in step S411, the data transfer indication message is transmitted via the network interface to the imbalanced BBU after the data transfer indication message is generated.

After receiving the data transfer indication message, the imbalanced BBU can generate a pause indication message carrying the pause time according to the data transfer indication message. Next, the imbalanced BBU transmits the pause indication message via the at least one RRH to the at least one UE connected to the imbalanced BBU via the at least one RRH. In this way, the at least one UE can enter a pause mode and keep in the pause mode during the pause time. Meanwhile, the imbalanced BBU transfers the service data associated with the at least one UE to the at least one target BBU. The at least one UE suspends the signal transmission with the at least one RRH when the at least one UE is in the pause mode.

In an embodiment, the management device may be a server. In another embodiment, the management device may be a BBU. Moreover, in an embodiment, the critical region may be a region where the resource utilization index is greater than an upper threshold value. In another embodiment, the critical region may be a region where the resource utilization index is lower than a lower threshold value.

In addition to the aforesaid steps, the management method of the present invention can also execute all the operations and have all the corresponding functions set forth in the aforesaid embodiments. How this embodiment executes these operations and has those functions will be readily appreciated by those who have ordinary skill in the art based on the explanation of the aforesaid embodiments, and thus will not be further described herein.

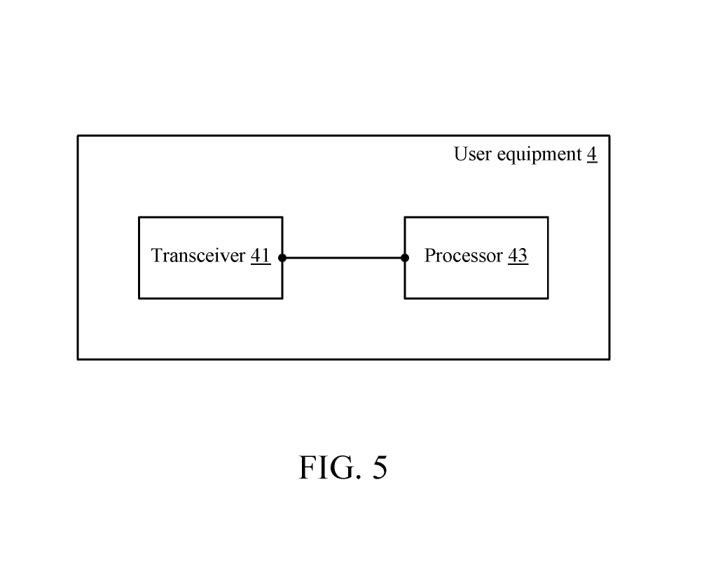

A fifth embodiment of the present invention is as shown in FIG. 5, which is a schematic view of a UE 4 of the present invention. The UE 4 comprises a transceiver 41 and a processor 43. The processor 43 is electrically connected to the transceiver 41. The processor 43 is configured to receive a pause indication message carrying a pause time via the transceiver 41 from an imbalanced BBU (e.g., the BBU 23 of FIG. 1A to FIG. 1B) and through an RRH (e.g., the RRH 32 of FIG. 1A to FIG. 1B), and make the UE 4 enters a pause mode in response to the pause indication message and keep the pause mode during the pause time to suspend the signal transmission with the RRH.

Thereafter, after the pause time expires, the processor 43 makes the UE 4 switches back to a normal transmission mode and receive a broadcast signal via the transceiver 41 from a target BBU (e.g., the BBU 22 of FIG. 1A to FIG. 1B) and through the RRH (e.g., the RRH 32 of the FIG. 1A to FIG. 1B) so as to retrieve a system parameter carried in the broadcast signal. As described above, in the exemplary example of FIG. 1A to FIG. 1B, the imbalanced BBU 23 transfers the service data associated the UE 4 to the target BBU 22.

In other embodiments, when the pause indication message transmitted by the RRH further comprises a pause start time, the processor 43 makes the UE 4 enters the pause mode at the pause start time according to the pause indication message. According to the above descriptions, the management mechanism of the present invention makes the imbalanced BBU transmit a pause indication message to the UE connected to the imbalanced BBU via at least one RRH connected to the imbalanced BBU before the imbalanced BBU transfers the service data to the target BBU so that the UE enters a pause mode and keeps in the pause mode during the pause time. Accordingly, the management mechanism of the present invention can effectively prevent the problems such as the disconnection of the user equipment or the loss of packet caused by RRH relocation.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A management device for a cloud radio access network (C-RAN), comprising:
a network interface, being configured to connect to a plurality of baseband units (BBUs); and
a processor electrically connected to the network interface, being configured to execute the following steps of:
(a) receiving a resource utilization index report indicating a resource utilization index from each of the BBUs via the network interface;
(b) among the BBUS, determining whether there is an imbalanced BBU, the resource utilization index of which is in a critical region;
(c) when the imbalanced BBU exists, determining at least one remote radio head (RRH) to be relocated among a plurality of RRHs connecting to the imbalanced BBU, and evaluating a volume of service data needed to be transferred, wherein the service data are associated with at least one user equipment connecting to the imbalanced BBU via the at least one RRH;
(d) selecting at least one target BBU, the resource utilization index of which is in a loadable region, from the BBUs and calculating a pause time according to the number of the at least one RRH and the volume of service data;
(e) generating a data transfer indication message carrying the pause time and identification information of the at least one target BBU;
(f) after generating the data transfer indication message, transmitting the data transfer indication message via the network interface to the imbalanced BBU to make the imbalanced BBU execute the following steps according to the data transfer indication message:
generating a pause indication message carrying the pause time;
transmitting the pause indication message via the at least one RRH to the at least one user equipment so that the at least one user equipment enters a pause mode and keeps in the pause mode during the pause time; and
transferring the service data associated with the at least one user equipment to the at least one target BBU.

2. The management device of claim 1, wherein the critical region is a region where the resource utilization index of the at least one target BBU is greater than an upper threshold value.

3. The management device of claim 1, wherein the critical region is a region where the resource utilization index of the at least one target BBU is lower than a lower threshold value.

4. The management device of claim 1, wherein the loadable region is a region where the resource utilization index of the at least one target BBU is not in the critical region after receiving the transferred service data.

5. The management device of claim 1, wherein the at least one user equipment suspends signal transmission with the at least one RRH when the at least one user equipment is in the pause mode.

6. The management device of claim 1, wherein the management device is one of a server and a BBU.

7. A user equipment, comprising:
a transceiver; and
a processor electrically connected to the transceiver, being configured to receive a pause indication message carrying a pause time via the transceiver from an imbalanced BBU and through an RRH, and make the user equipment enter a pause mode in response to the pause indication message and keep the pause mode during the pause time;
wherein the processor further makes the user equipment switch back to a normal transmission mode after the pause time expires and receive a broadcast signal via the transceiver from a target BBU and through the RRH so as to retrieve a system parameter carried in the broadcast signal, and the imbalanced BBU transfers service data associated with the user equipment to the target BBU.

8. The user equipment of claim 7, wherein the pause indication message further comprises a pause start time, and the processor further makes the user equipment enter the pause mode at the pause start time.

9. A management method for a management device for a cloud radio access network (C-RAN), the management device comprising a network interface and a processor, the network interface connecting to a plurality of BBUs, and the processor being electrically connected to the network interface, the management method being executed by the processor and comprising:
(a) receiving a resource utilization index report indicating a resource utilization index from each of the BBUs via the network interface;
(b) among the BBUs, determining whether there is an imbalanced BBU, the resource utilization index of which is in a critical region;
(c) when the imbalanced BBU exists, determining at least one remote radio head (RRH) to be relocated among a plurality of RRHs connecting to the imbalanced BBU, and evaluating a volume of service data needed to be transferred, wherein the service data are associated with at least one user equipment connecting to the imbalanced BBU via the at least one RRH;
(d) selecting at least one target BBU, the resource utilization index of which is in a loadable region, from the BBUs and calculating a pause time according to the number of the at least one RRH and the volume of service data;
(e) generating a data transfer indication message carrying the pause time and identification information of the at least one target BBU;
(f) after generating the data transfer indication message, transmitting the data transfer indication message via the network interface to the imbalanced BBU to make the imbalanced BBU execute the following steps according to the data transfer indication message:
generating a pause indication message carrying the pause time;
transmitting the pause indication message via the at least one RRH to the at least one user equipment so that the at least one user equipment enters a pause mode and keeps in the pause mode during the pause time; and
transferring the service data associated with the at least one user equipment to the at least one target BBU.

10. The management method of claim 9, wherein the critical region is a region where the resource utilization index of the at least one target BBU is greater than an upper threshold value.

11. The management method of claim 9, wherein the critical region is a region where the resource utilization index of the at least one target BBU is lower than a lower threshold value.

12. The management method of claim 9, wherein the loadable region is a region where the resource utilization index of the at least one target BBU is not in the critical region after receiving the transferred service resource.

13. The management method of claim 9, wherein the at least one user equipment suspends signal transmission with the at least one RRH when the at least one user equipment is in the pause mode.

14. The management method of claim 9, wherein the management device is one of a server and a BBU.
